(19) United States
(12) Patent Application Publication
(10) Pub. No.: US 2008/0181092 A1
(43) Pub. Date: Jul. 31, 2008

(54) Halftoning curved images

(76) Inventor: Paul J. McClellan, Bend, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/627,634

(22) Filed: Jan. 26, 2007

(51) Int. Cl. G11B 3/70; G06K 15/00

(52) U.S. Cl. 369/273; 358/3.06

(57) ABSTRACT

A rectangular image to be imaged on a flat curved surface is received. The rectangular image is converted to a curved image corresponding to the flat curved surface. The curved image is halftoned. The curved image as halftoned is imaged on the flat curved surface.

### BACKGROUND

Many types of optical discs include a data side and a label side. The data side is where the data is written to, whereas the label side allows the user to label the optical disc. Unfortunately, labeling can be an unprofessional, laborious, and/or expensive process. Markers can be used to write on optical discs, but the results are decidedly unprofessional looking. Special pre-cut labels that can be printed on with inkjet or other types of printers can also be used, but this is a laborious process: the labels must be carefully aligned on the discs, and so on. Special-purpose printers that print directly on the discs may be used, but such printers are fairly expensive. In the patent application entitled “Integrated CD/DVD Recording and Label” [attorney docket 10011728-1], filed on Oct. 11, 2001, and assigned Ser. No. 09/976,877, a solution to these difficulties is described, in which a laser is used to label optical discs.

The approach described in the referenced patent application is capable of optically writing to the optically writable label surface of an optical disc in black and white. That is, for a given location on the label surface, this approach can either write a black mark, or write no mark at all, which corresponds to a white mark. However, users commonly wish to optically write non-black-and-white images, such as grayscale images, to the optically writable label surfaces of optical discs. To achieve this, halftoning is typically performed on a grayscale image prior to writing it on the label surface. Conventional halftoning approaches, however, are applicable to rectangular images, not curved images as can be written to flat curved surfaces like optical disc surfaces. As such, halftoning is usually performed prior to converting a rectangular image to a curved image, which ultimately can lead to degraded image quality.

### BRIEF DESCRIPTION OF THE DRAWINGS

FIG. 1 is a diagram of an optical disc device, according to an embodiment of the invention.

FIG. 2 is a diagram of a representative rectangular image, according to an embodiment of the invention.

FIG. 3 is a diagram of the representative image of FIG. 2 after conversion from rectangular to curved and as has been optically written on the optically writable label side of an optical disc, according to an embodiment of the invention.

FIG. 4 is a diagram of an example image that has been halftoned, and after halftoning, has been converted from rectangular to curved and then optically written on the optically writable label side of an optical disc, according to the prior art.

FIG. 5 is a diagram of the example image of FIG. 4 that has first been converted from rectangular to curved before being halftoned, and then optically written on the optically writable label side of an optical disc, according to an embodiment of the invention.

FIG. 6 is a flowchart of a method in which an image is halftoned after conversion from rectangular to curved, according to an embodiment of the invention.

FIG. 7 is a diagram of a halftoning approach in relation to a rectangular image that can also be employed in relation to a curved image, according to an embodiment of the invention.

FIGS. 8A, 8B, and 8C are diagrams of an image portion having concentric circular tracks of pixels, or locations, and how the pixels can be “unwound” or “unrolled” in a linear fashion, according to varying embodiments of the invention.

FIG. 9 is a diagram of a halftoning approach that is normally employed in relation to a rectangular image but that instead is employed in relation to a curved image, according to an embodiment of the invention.

### DETAILED DESCRIPTION OF THE DRAWINGS

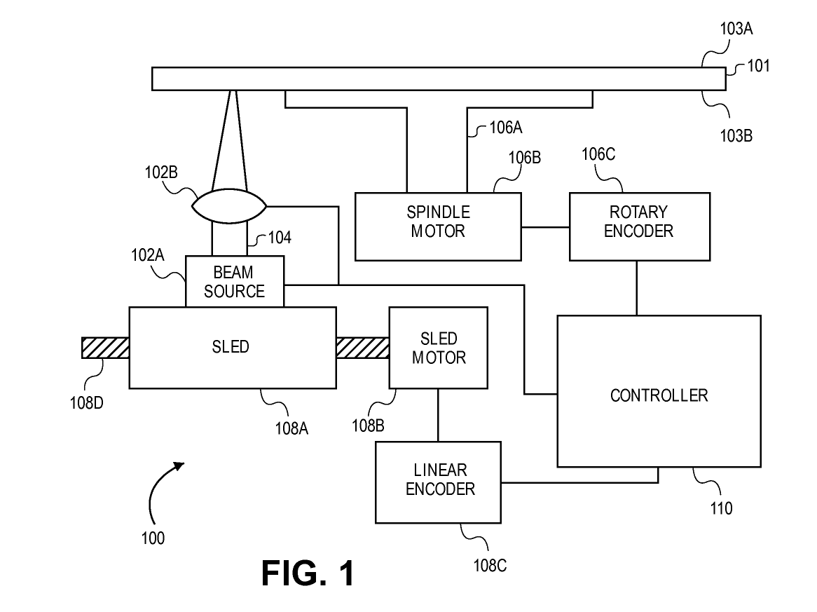

FIG. 1 shows an optical disc device 100, according to an embodiment of the invention. The optical disc device 100 is for reading from and/or writing to an optical disc 101 inserted into the optical disc device 100 and that has a label area and a data area. In one embodiment, the label area of disc 101 is a label side 103B and the data area is a data side 103A opposite the label side 103B. More specifically, the optical disc device 100 is for reading from and/or writing to an optically writable label side 103B of the optical disc 101, and/or an optically writable data side 103A of the optical disc 101, which are collectively referred to as the sides 104 of the optical disc 101. The optically writable data side 103A is more generally an optically writable data surface, and the optically writable label side 103B is more generally an optically writable label surface.

The optically writable data side 103A of the optical disc 101 includes a data region on which data may be optically written to and/or optically read by the optical disc device 100. The data side 103A is thus the side of the optical disc 101 to which binary data readable by the optical disc device 100 and understandable by a computing device is written, and can be written by the optical disc device 100 itself. For instance, the data side 103A may be the data side of a compact disc (CD), a CD-readable (CD-R), which can be optically written to once, a CD-readable/writable (CD-RW), which can be optically written to multiple times, and so on. The data side 103A may further be the data side of a digital versatile disc (DVD), a DVD-readable (DVD-R), or a DVD that is readable and writable, such as a DVD-RW, a DVD-RAM, or a DVD+RW. The data side 103A may also be the data side of a high-capacity optical disc, such as a Blu-ray optical disc, a High Definition (HD) DVD optical disc, and so on. Furthermore, there may be a data region on each side of the optical disc 101, such that the optical disc is double sided, and such that there is a label region on at least one of the sides of the disc.

The label side 103B is the side of the optical disc 101 to which visible markings can be optically written to realize a desired label image. For instance, the label side 103B may be part of an optical disc that is disclosed in the previously filed patent application assigned Ser. No. 09/976,877, which discloses an optically writable label side of an optical disc. It is noted that in other embodiments at least one of the sides 103A and 103B of the optical disc 101 may have both label regions and data regions.

The optical disc device 100 includes a beam source 102A and an objective lens 102B, which are collectively referred to as the optomechanical mechanism 102. For exemplary purposes only, the optically writable label side 103B of the optical disc 101 is depicted as being incident to the optomechanical mechanism 102 in FIG. 1, such that the optical disc device 100 is or is about to optically write an image to the label side 103B. The optical disc device 100 also includes a spindle 106A, a spindle motor 106B, and a rotary encoder 106C, which are collectively referred to as the first motor mechanism 106. The device 100 includes a sled 108A, a sled motor 108B, a linear encoder 108C, and a rail 108D, which are collectively referred to as the second motor mechanism 108. Finally, the optical disc device 100 includes a controller 110.

The optomechanical mechanism 102 focuses an optical beam 104 on the optical disc 101. Specifically, the beam source 102A generates the optical beam 104, which is focused through the objective lens 102B onto the optical disc 101. The first motor mechanism 106 rotates the optical disc 101. Specifically, the optical disc 101 is situated on the spindle 106A, which is rotated, or moved, by the spindle motor 106B to a given position specified by the rotary encoder 106C communicatively coupled to the spindle motor 106B. The rotary encoder 106C may include hardware, software, or a combination of hardware and software. The second motor mechanism 108 moves the optomechanical mechanism 102 radially relative to the optical disc 101. Specifically, the optomechanical mechanism 102 is situated on the sled 108A, which is moved on the rail 108D by the sled motor 108B to a given position specified by the linear encoder 108C communicatively coupled to the sled motor 108B. The linear encoder 108C may include hardware, software, or a combination of hardware and software.

The controller 110 selects positions on the optical disc 101 at which the optical beam 104 is to be focused for optically writing to and/or optically reading from such positions, by controlling the optomechanical mechanism 102 as well as the first motor mechanism 106 and the second motor mechanism 108. The optomechanical mechanism 102 is able to control the beam 104 generated by the beam source 102A, the focusing of the beam 104 through the objective lens 102B, the spindle motor 106B through the rotary encoder 106C, and the sled motor 108B through the linear encoder 108C. The controller 110 may include hardware, software, or a combination of hardware and software.

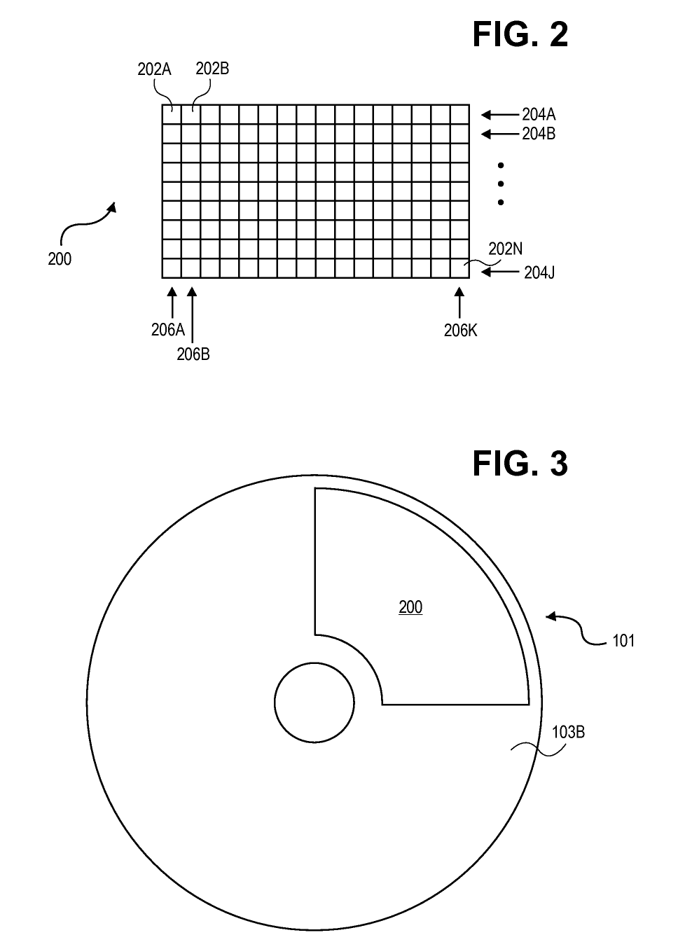

FIG. 2 shows a representative rectangular image 200 that is desired to be optically written onto the optically writable label side 103B of the optical disc 101, according to an embodiment of the invention. The rectangular image 200 includes a number of pixels 202A, 202B, . . . , 202N, collectively referred to as the pixels 202. The pixels 202 may also be referred to as locations of the rectangular image 200. The pixels 202 are organized in a rectangular grid having a number of rows 204A, 204B, . . . , 204J, collectively referred to as the rows 204, and a number of columns 206A, 206B, . . . , 206K, collectively referred to as the columns 206.

Each of the pixels 202 of the rectangular image 200 has one or more values that define the pixel, such that the values of all the pixels 202 together define the image 200. In one embodiment of the invention, the rectangular image 200 is a grayscale image. As such, each of the pixels 202 has a grayscale value. For example, each pixel of an eight-bit grayscale image 200 can have one of 2⁸=256 different levels of grayscale, from 0 to 255. In another embodiment, the rectangular image 200 is a color image. As such, each of the pixels 202 has a value for each of a number of different color components. For example, each pixel of a color image 200 may have a red color component value, a green color component value, and a blue color component value.

FIG. 3 shows the image 200 having been converted to a curved image and optically written on the optically writable label side 103B of the optical disc 101, according to an optical disc. As will be described in more detail later in the detailed description, at least two actions may be performed to prepare the image 200 in preparation for optically writing it to the label side 103B. First, the image 200 is converted to a curved image, corresponding to the flat curved label surface of the optical disc 101. Second, the curved image 200 is halftoned, so that each of its pixels 202 is ultimately written on the label side 103B as a black mark or as a white mark.

That is, the image 200 is a grayscale or a color image, but the optical disc device 100 may be capable of just forming black-and-white images on the optically writable label side 103B of the optical disc 101. Therefore, the image 200 is converted to grayscale and halftoned, which is the process by which the values of the pixels of the image 200 are each converted to black or white in a manner that still represents the content of the image 200. Halftoning enables the image 200 to be perceptually imaged on the optically writable label side 103B of the optical disc 101, even though the image 200 is in grayscale or in color and the optical disc device 100 is capable of just forming black-and-white images on the label side 103B of the optical disc 101. However, in another embodiment, the optical disc device 100 may be cable of forming color images on the label side 103B of the optical disc 101 as well; at least some embodiments of the invention are applicable to such an optical disc device.

Conventional halftoning approaches are operable on rectangular images. Therefore, conventionally halftoning is performed on the rectangular image 200, and thereafter the rectangular image 200 is converted to a curved image. In one embodiment, conversion of the rectangular image 200 to a curved image is performed as described in the previously filed patent application entitled “Label an optical disc” [attorney docket No. 200315685-1], filed on Apr. 30, 2004, and assigned Ser. No. 10/836,167. However, performing halftoning prior to rectangular-to-curved conversion can introduce subtle artifacts into the resultant image optically written on the optically writable label side 103B of the optical disc 101. Therefore, at least some embodiments of the invention are concerned with halftoning the image 200 after the image 200 has been converted from rectangular to curved. The net result is that the resultant image optically written on the label side 103B of the optical disc 101 has fewer artifacts and thus suffers less image degradation than if halftoning were performed prior to rectangular-to-curved conversion.

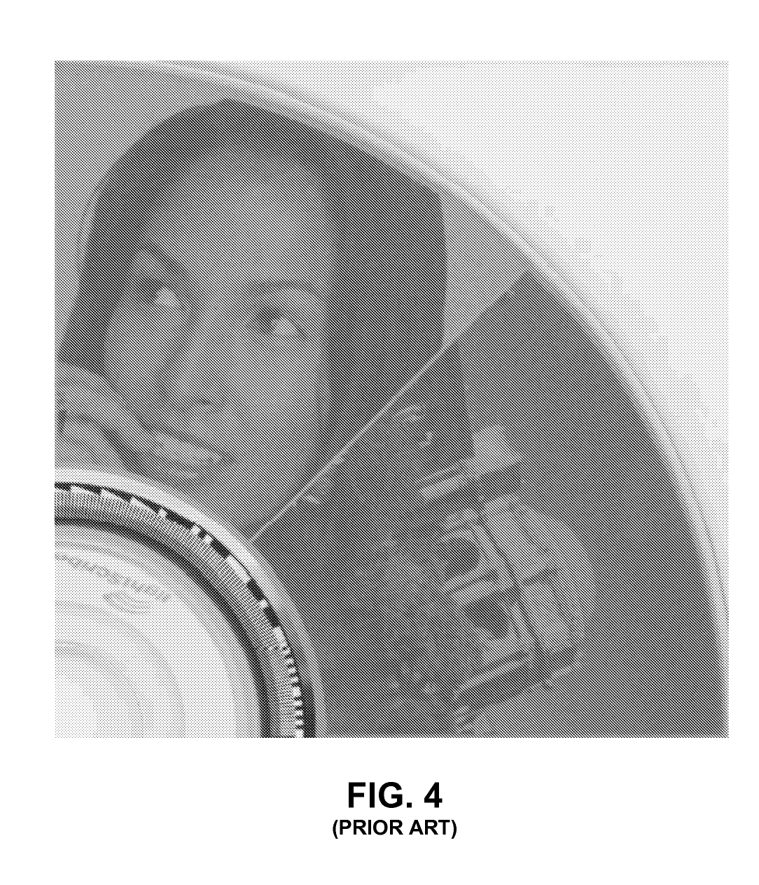

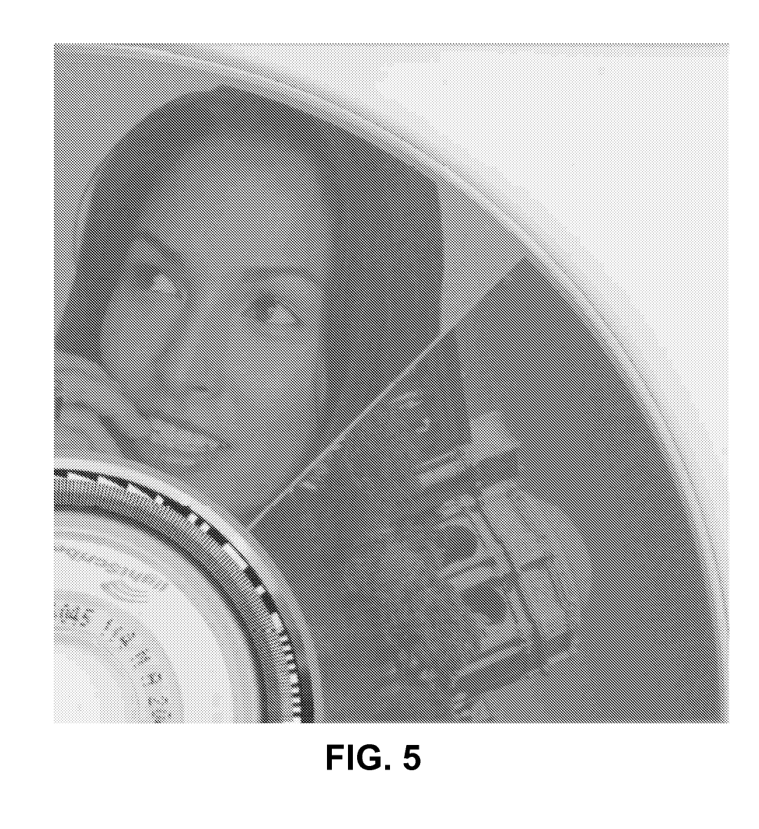

FIG. 4 shows a representative image that has been optically written on an optically writable label surface of an optical disc, according to the prior art, whereas FIG. 5 shows the representative image that has been optically written on an optically writable label surface of an optical disc, according to an embodiment of the invention. In FIG. 4, the image is halftoned prior to conversion from rectangular to curved. By comparison, in FIG. 5, the image is first converted from rectangular to curved prior to being halftoned. The image in FIG. 5 shows fewer artifacts than the image in FIG. 4 does, in that FIG. 5 shows less graininess and retains more fine detail than FIG. 4 does. For example, the woman's forehead and the sky above the building exhibit less graininess in FIG. 5 than they do in FIG. 4. As another example, the woman's eyelashes are more visible and easily discernable in FIG. 5 as compared to FIG. 4.

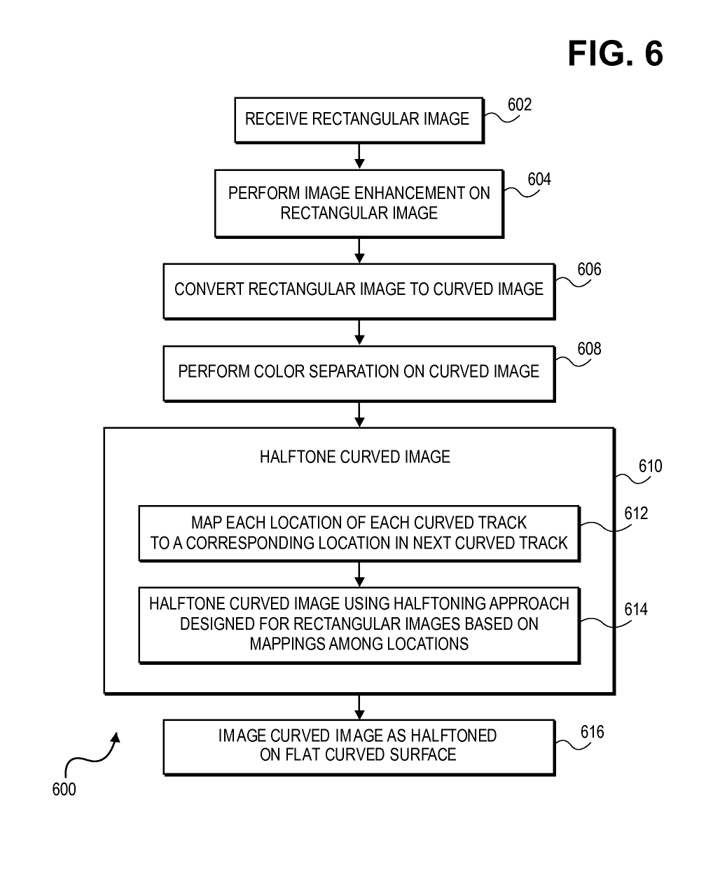

FIG. 6 shows a method 600, according to an embodiment of the invention. The method 600 may be performed by a computer program stored on a computer-readable medium, like a tangible medium such as a recordable data storage medium. In one embodiment, the method 600 may be performed within the optical disc device 100 that has been described, such as by the controller 110 thereof. In another embodiment, the method 600 may be performed by a computing device, such as a desktop or a laptop computer, to which the optical disc device 100 is a part or otherwise is communicatively connected.

The rectangular image 200 is received (602). The rectangular image 200 may be a color image or a grayscale image. The image 200 may be received as generated or otherwise obtained by a user, where the user wishes to image a curved version of the image 200 on a flat curved surface. For instance, the user may wish to optically write a curved version of the image 200 on the optically writable label side 103B of the optical disc 101.

Image enhancement may be performed on the image 200 while it remains in rectangular form (604). Such image enhancement may be conventional, as known within the art. Image enhancement may particularly be performed to the image 200 so that a reasonable match between the rectangular version of the image 200 and the subsequently converted to curved version of the image 200 will be achieved. For example, pixel replication or resolution enhancement may be performed, as known to those of ordinary skill within the art. Smoothed sub-sampling may also be achieved to reduce the resolution if it is too high as compared to the resolution at which the optical disc device 100 can form marks on the optically writable label side 103B of the optical disc 100.

Thereafter, the image 200 is converted from being rectangular to being curved (606). As can be appreciated by those of ordinary skill within the art different types of interpolation can be performed to convert the image 200 to curved form. In one embodiment, the curved image 200 is described using a non-Cartesian coordinate system, such that as presented in the previously filed patent application entitled “Optical disc non-Cartesian coordinate system” [attorney docket No. 200207926-1], filed on Dec. 12, 2002, and assigned Ser. No. 10/317,894.

Color separation may be performed on the curved image 200 (608), where the curved image 200 is a full-color image. By comparison, color separation is typically not needed where the curved image 200 is a grayscale image. Color separation in one embodiment involves converting the red, green, and blue color component values of pixels of the curved image 200 to cyan, magenta, yellow, and black color component values. During such color separation, adjustments to the colors of the pixels of the image 200 may also be performed so that the resultant halftoned curved image 200 is imaged on a flat curved surface as accurately as possible.

The curved image 200 is then halftoned (610). Halftoning is the process by which, for each pixel of the curved image 200, whether a black pixel or a white pixel should be correspondingly imaged on the flat curved surface in question. In the context of printing, such as optically writing an image on a label surface of an optical disc, each such black pixel is optically written by optically writing a mark on the label surface. By comparison, each white pixel is imaged in the context of printing by not optically writing a mark on the label surface. Thus, imaging a white pixel at a location of an image in the context of printing can mean not printing a black pixel (i.e., a mark) at this location. Each pixel of the curved image 200 has one or more non-binary values, such as a number of color component values, or a grayscale value. Therefore, halftoning determines whether each pixel should be imaged as a black pixel or a white pixel. Stated another way, halftoning effectively converts the pixels of the image 200 to binary pixels, having an on/black or an off/white state.

In one embodiment, the curved image 200 is halftoned using a halftoning approach designed for rectangular images. More specifically, the halftoning approach is modified or adjusted for use with the curved image 200. An example of such a halftoning approach that can be adjusted for utilization with the curved image 200 is the Floyd-Steinberg error diffusion approach, as known to those of ordinary skill within the art. The Floyd-Steinberg approach to halftoning compares the value of a pixel to a threshold. If the value is greater than the threshold, then a black mark is to be printed for the pixel, and otherwise the pixel is left unmarked by not printing a black mark for the pixel.

In the Floyd-Steinberg approach, a minimum value or a maximum value, depending on whether a white mark or a black mark is selected for a pixel, is subtracted from the value of the pixel, where the difference is referred to as the error for the pixel. This error is then diffused among a number of neighboring pixels, such that the values of these neighboring pixels are adjusted based on a portion of the error. This process is repeated on a pixel-by-pixel basis until whether a black pixel or no pixel is to be printed for each pixel has been determined.

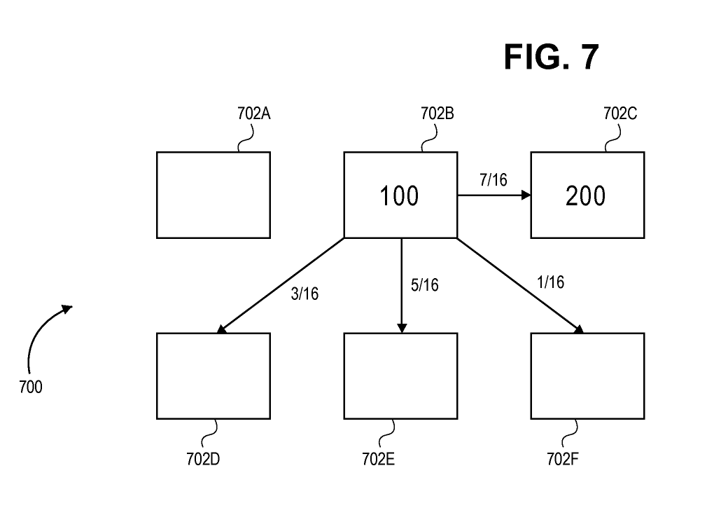

FIG. 7 shows a portion 700 of a representative rectangular image in accordance with which an example of the Floyd-Steinberg error diffusion approach is described, where this approach can be modified for usage with curved images, according to an embodiment of the invention. The image portion 700 includes pixels 702A, 702B, 702C, 702D, 702E, and 702F, collectively referred to as the pixels 702. The pixel 702B particularly has a value of 100 whereas the pixel 702C particularly has a value of 200. In the example of FIG. 7, the rectangular image of which the portion 700 is a part is being processed row-by-row from top to bottom, and within each row pixel-by-pixel from left to right.

As to the pixel 702B, the value 100 is compared to a threshold. The threshold may be static or dynamic. For simplicity, it is presumed that the threshold is 128. Where the value of a pixel is greater than the threshold, then a black mark is to be printed for the pixel, corresponding to a value of 255 for eight-bit grayscale, whereas if the value is less than the threshold, then no mark is to be printed, corresponding to a value of 0. Therefore, because the value 100 is less than the threshold of 128, no mark is to be printed for the pixel 702B.

The error for the pixel 702B is determined as the value of the pixel —100−minus the value corresponding to no mark −0. Thus, the error for the pixel 702B is 100−0=100. This error is diffused among the pixels 702C, 702D, 702E, and 702F, as shown in FIG. 7. Therefore, 7/16 of the error is added to the value of the pixel 702C, 3/16 of the error is added to the value of the pixel 702D, 5/16 of the error is added to the value of the pixel 702E, and 1/16 of the value is added to the value of the pixel 702F. The weights 7/16, 3/16, 5/16, and 1/16 may be static, or they may be dynamic, but in the example of FIG. 7, the weights are presumed to be static for simplicity.

Therefore, the new value of the pixel 702C is its original value of 200, plus the 7/16 of the error of 100, or 200+44 (rounded)=244. Thus, the error diffusion approach proceeds to the pixel 702C, as the next pixel in the current row of the image portion 700. The value of the pixel 702C, 200, is compared to the threshold of 128. Because the value of the pixel 702C is greater than the threshold, a black mark is to be printed for the pixel 702C. The error for the pixel 702C is determined as the value of the pixel—244−minus the value corresponding to the to-be-printed black mark −255. Therefore, the error for the pixel 702B is 244−255=−11. This error is diffused to the neighboring pixels of the pixel 702C, the error diffusion approach proceeds to the next pixel, and so on.

For each of the pixels 702 of the image portion 700, then, the error is diffused among four different pixels: the next pixel to the right in the current row; the pixel in the next row and to the left; the immediately adjacent pixel in the next row; and, the pixel in the next row and to the right. For the pixel 702B, for instance, these four pixels, respectively, are the pixels 702C, 702D, 702E, and 702F.

At the last pixel of a row, where there is no pixel to the right in the current row and no pixel to the right in the next row, as well as for each pixel within the last row, where there is no next row, the diffused errors may simply be discarded in one embodiment. Furthermore, the basic approach described in relation to FIG. 7 can be modified in a number of different ways, as can be appreciated by those of ordinary skill within the art. For example, processing across the rows may alternate from left to right and from right to left. As another example, the error diffusion weights at the borders of the image may be adjusted so as not to discard diffused errors at these locations.

Referring back to FIG. 6, in order for a halftoning approach designed for conventional rectangular images to instead be employed, therefore, embodiments of the invention map locations (i.e., pixels) of each curved track of the flat curved surface on which the curved image 200 is to be imaged to correspondingly adjacent locations of the next track (612). That is, for each pixel 702B of a curved track (using the nomenclature of FIG. 7), what is determined is which pixel on the next curved track corresponds to this pixel 702B, as the immediately adjacent pixel 702E on the next curved track. Once this immediately adjacent pixel 702E on the next curved track is determined, the other pixels 702C, 702D, and 702F are easily determined. In particular, the pixel 702C is the pixel immediately adjacent to the pixel 702B on the same curved track, the pixel 702D is the pixel to the left of the pixel 702D, and the pixel 702F is the pixel to the right of the pixel 702E.

In other words, the pixels of each curved track of the flat curved surface on which the curved image 200 is to be imaged are mapped so that each pixel of each curved track is mapped to a correspondingly adjacent pixel to the next curved track. If a current pixel of a current curved track is the pixel 702B, the mapping determines which pixel of the next curved track is the pixel 702E. The pixel 702C is defined as the next pixel on the current track, whereas the pixel 702D is defined as the previous pixel to the pixel 702E, and the pixel 702F is defined as the next pixel to the pixel 702E. An illustrative example of such mapping is now presented to provide further explanation.

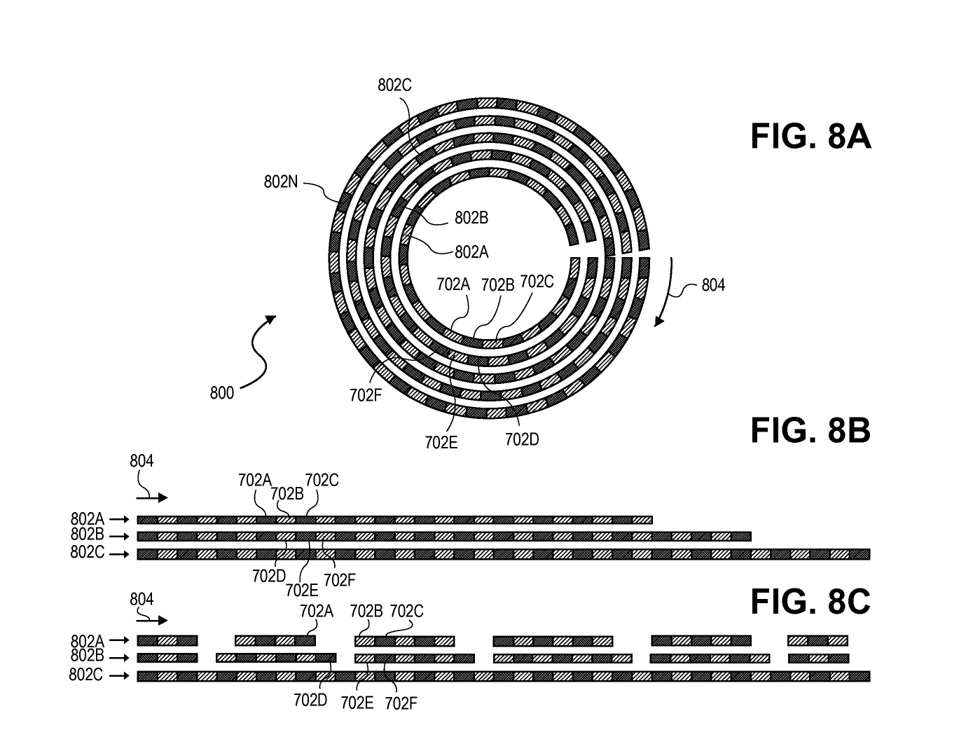

FIG. 8A shows a representative flat curved surface 800, according to an embodiment of the invention. The curved surface 800 has a number of concentric circular tracks, from an innermost track 802A to an outermost track 802N. These are the circular tracks 802A, 802B, 802C, . . . , 802N, collectively referred to as the circular tracks 802. The pixels of the tracks 802 are substantially the same size, and are colored in two different ways in FIG. 8A for illustrative clarity. The pixels 702 are depicted in FIG. 8A as representative pixels along the tracks 802A and 802B. The pixels 702 are ordered in a clockwise manner, as indicated by the arrow 804.

FIG. 8B shows three tracks 802A, 802B, and 802C “unwound” or “unrolled” in rectilinear fashion, according to an embodiment of the invention. The arrow 804 is again depicted. Unrolling the tracks 802A, 802B, and 802C yields the pixels 702 as not correctly mapped. That is, the pixel 702E, which is defined as the pixel on the track 802B that is most immediately adjacent to the pixel 702B on the track 802A, is in fact not immediately adjacent to the pixel 702B in FIG. 8B, but actually is adjacent to the pixel to the right of the pixel 702C on the track 802A.

By comparison, FIG. 8C shows the three tracks 802A, 802B, and 802C again “unwound” or “unrolled” in rectilinear fashion, but where spacings among the pixels thereof have been introduced to preserve the relative positions of pixels among adjacent tracks, according to an embodiment of the invention. The arrow 804 is again depicted. In FIG. 8C, it is shown that the pixel 702E is immediately adjacent to the pixel 702B on an inter-track basis. FIG. 8C also shows that the pixel 702D is to the left of the pixel 702E and the pixel 702F is to the right of the pixel 702E, as before. The spacing between the pixels 702D and 702E has been inserted in FIG. 8C to preserve the proper spatial relationship between the pixels 702E and 702B. The pixel 702A is to the left of the pixel 702B and the pixel 702C is to the right of the pixel 702B. The double spacing between the pixels 702A and 702B has been inserted in FIG. 8C to preserve the proper spatial relationship between the pixels 702E and 702B.

Therefore, the mapping of each pixel of each curved track to a correspondingly adjacent pixel on the next curved track in part 612 of the method 600 of FIG. 6 is achieved so that a halftoning approach designed for rectangular images can instead be performed in relation to curved images. For each pixel 702B on a given track, in other words, the correspondingly adjacent pixel 702E on the next track is mapped. Once this mapping has been determined, the other relevant pixels to the pixel 702B—the pixels 702C, 702D, and 702F—are easily determined in relation to the pixel 702B or in relation to the pixel 702E.

Algorithmically, each of the curved tracks 802 of the flat curved surface 800 has a radius defined by:

CTR=FTR+CTC·TS, (1)

where CTR is the radius of the curved track in question. FTR is the radius of the first curved track 802A, in a given unit of measure. CTC is the number (or index) of the curved track in question, where the first curved track 802A has a number (or index) of zero. TS is the (constant) spacing between adjacent curved tracks 802. Furthermore, each pixel, or each location, on each curved track has an index CI, where the first location has a CI of zero. The correspondingly adjacent pixel on the next track has an index NI on this next track. NI can be specified as:

$$NI = round ( CI + \frac{CI \cdot TS}{CTR} ) , \qquad ( 2 )$$

where round (·) is a rounding function. Substituting equation (1) in equation (2) for CTR yields:

$$NI = round ( CI + \frac{CI \cdot TS}{FTR + CTC \cdot TS} ) . \qquad ( 3 )$$

Thus, for each pixel of each curved tracking having an index CI on a current track, the correspondingly adjacent pixel on the next track, having the index NI on that track, can be identified by using equation (3).

The examples of FIGS. 8A-8C have been described in relation to a flat curved surface 800 on which circular tracks 802 are defined from a first, innermost track having a smallest radius to a last, outermost track having a largest radius. In other embodiments of the invention, however, the tracks may still be concentric and circular, but may be ordered from a first, outermost track having a largest radius to a last, innermost track having a smallest radius. In still other embodiments of the invention, the curved tracks may be spiral tracks, as can be appreciated by those of ordinary skill within the art, instead of concentric circular tracks.

Referring still to FIG. 6, once the locations of each curved track have been mapped to correspondingly adjacent locations in a next curved track (612), the curved image 200 can be halftoned using a halftoning approach designed rectangular images based on these mappings (614). For instance, the Floyd-Steinberg approach that has been illustratively depicted in FIG. 7 is applicable to the curved image 200 that has been mapped onto the curved surface 800 of FIGS. 8A-8C. Since the correspondingly adjacent location on the next track has been determined in part 612 for each location on each track, the other relevant locations needed to apply the Floyd-Steinberg approach are easily determined, such that the Floyd-Steinberg approach can be performed even in relation to the curved image 200.

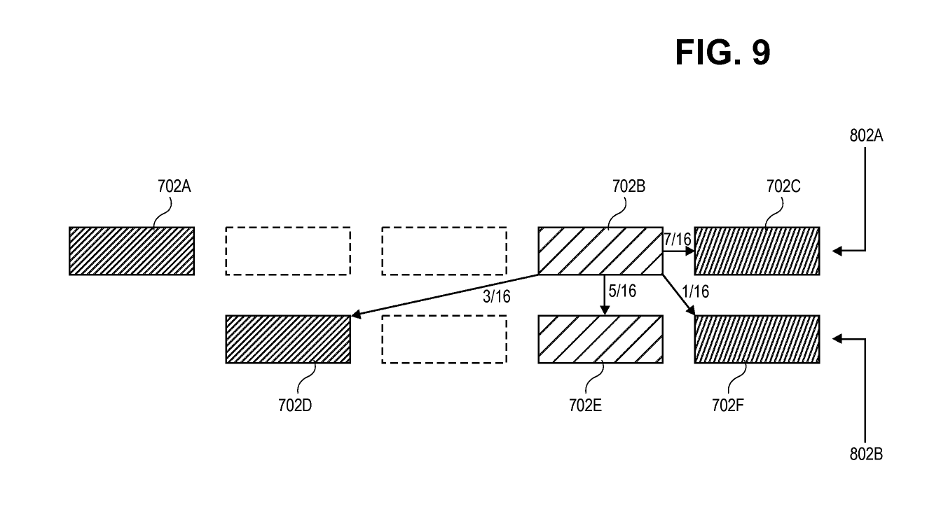

FIG. 9 shows an example of applying the Floyd-Steinberg approach to halftoning as to the pixels 702 on the concentric circular tracks 802 of the image portion 800, according to an embodiment of the invention. As has been noted, the correspondingly adjacent pixel in the track 802B to the pixel 702B in the track 802A is the pixel 702E. The pixel 702D is defined as the pixel to the left of the pixel 702E, and the pixel 702F is defined as the pixel to the right of the pixel 702E. The pixel 702C is the pixel to the right of the pixel 702B. Thus, as to the pixel 702B, the error resulting from comparing the value of the pixel 702B is diffused among the pixels 702C, 702D, 702E, and 702F as has been described.

It is noted that the pixel 702D to the left of the pixel 702E is actually adjacent to the pixel 702E. However, a spacing between these pixels 702D and 702E is shown in FIG. 9 as a construct to preserve the positioning of the pixels of the track 802A relative to the pixels of the track 802B. The same is true for the pixel 702A in relation to the pixel 702B. The pixel 702A is actually adjacent to the pixel 702B, but two spacings between these pixels 702D and 702E are shown in FIG. 9 to preserve the positioning of the pixels of the track 802A relative to the pixels of the track 802B and the positioning of the pixels of the track 802B relative to the pixels of the track 802C.

The halftoning process is repeated for each pixel, or location, of each track, starting from an initial predetermined track and proceeding to a last predetermined track. In the example of FIG. 8A, for instance, the initial track is the innermost track 802A and the last track is the outermost track 802N. In another embodiment, as has been noted, the initial track may be the outermost track 802N and the last track may be the innermost track 802A. In a given track, the halftoning process is started at a first pixel, or location, and proceeding to a last pixel, or location, in a given direction. In the example of FIG. 8A, for instance, this direction is clockwise as denoted by the arrow 804, but in another embodiment, the direction may be counter-clockwise.

Referring back to FIG. 6, once the curved image 200 has been halftoned, it is imaged on the flat curved surface in question (616). For instance, the curved image 200 may be optically written to the optically writable label side 103B of the optical disc 101 using the optical disc device 101. The optical disc device 100 may thus be appropriately controlled appropriately to optically write the curved image 200 as halftoned to the label side 103B. In another embodiment, the controller 110 may control the optomechanical mechanism 102 to optically write the curved image 200 as halftoned to the label side 103B. Other types of imaging the curved image 200 on flat curved surfaces are also amenable to embodiments of the invention.

At least some embodiments of the invention provide for advantages over the prior art. As has been described, halftoning an image after converting the image from rectangular to curved provides for better image quality. In addition, at least some embodiments of the invention can employ any type of halftoning approach that is normally performed in relation to rectangular images. This is because the locations, or pixels, of each curved track of a flat curved surface are mapped to correspondingly adjacent locations on the next curved track of the flat curved surface, such that existing halftoning approaches for rectangular images can be employed even in relation to curved images.

We claim:

1. A method comprising:
receiving a rectangular image to be imaged on a flat curved surface;
converting the rectangular image to a curved image corresponding to the flat curved surface;
halftoning the curved image; and,
imaging the curved image as halftoned on the flat curved surface.

2. The method of claim 1, wherein halftoning the curved image comprises determining whether a black pixel or a white pixel is to be imaged for each location of a plurality of locations of the curved image, each location having a non-binary value.

3. The method of claim 2, wherein a white pixel is imaged for a location of the curved image by not printing a black pixel at the location.

4. The method of claim 1, wherein halftoning the curved image comprises determining whether a first color pixel or a second color pixel is to be imaged for each location of a plurality of locations of the curved image, each location having a non-binary value

5. The method of claim 1, wherein halftoning the curved image comprises adjusting a halftoning approach designed for rectangular images so that the halftoning approach can be employed in relation to the curved image.

6. The method of claim 1, wherein halftoning the curved image comprises:
for each curved track of a plurality of curved tracks of the flat curved surface,
for each location of a plurality of locations on the curved track,
mapping the location to a corresponding location in a next curved track of the flat curved surface, the location on the curved track mapped to the corresponding location in the next curved track that is most closely adjacent thereto; and,
employing a halftoning approach designed for rectangular images in relation to the curved image using mappings among the locations of the curved tracks.

7. The method of claim 6, wherein each curved track has a radius defined by CTR=FTR+CTC*TS, where CTR is the radius of the curved track, FTR is the radius of a first curved track of the plurality of curved tracks, CTC is a number of the curved track where the first curved track has a CTC of zero, and TS is a spacing between adjacent curved tracks.

8. The method of claim 7, wherein each location on the curved track has an index CI, where a first location on the curved track has a CI of zero, and wherein the corresponding location in the next curved track for the location on the curved track has an index defined by NI=round(CI+(CI*TS)/CTR), where NI is the index of the corresponding location in the next curved track and round (·) is a rounding function.

9. The method of claim 6, wherein the tracks are ordered from an innermost track having a smallest radius to an outermost track having a largest radius.

10. The method of claim 6, wherein the curved tracks are spiral tracks.

11. The method of claim 6, wherein the curved tracks are concentric circular tracks.

12. The method of claim 1, further comprising:
performing image enhancement of the rectangular image prior to converting the rectangular image to the curved image; and,
performing color separation on the curved image prior to halftoning the curved image.

13. The method of claim 1, wherein imaging the curved image as halftoned on the flat curved surface comprises optically writing the curved image as halftoned on an optically writable label surface of an optical disc, such that the flat curved surface is the optically writable label surface of the optical disc.

14. A computer-readable medium having a computer program stored thereon to perform a method comprising:
receiving a rectangular image to be optically written on an optically writable label surface of an optical disc;
converting the rectangular image to a curved image corresponding to the optically writable label surface of the optical disc;
halftoning the curved image; and,
controlling an optical disc device to optically write the curved image as halftoned on the optically writable label surface of the optical disc.

15. The computer-readable medium of claim 14, wherein halftoning the curved image comprises:
for each curved track of a plurality of curved tracks of the optically writable label surface of the optical disc,
for each location of a plurality of locations on the curved track,
mapping the location to a corresponding location in a next curved track of the optically writable label surface, the location on the curved track mapped to the corresponding location in the next curved track that is most closely adjacent thereto; and,
employing a halftoning approach designed for rectangular images in relation to the curved image using mappings among the locations of the curved tracks.

16. The computer-readable medium of claim 15, wherein each curved track has a radius defined by CTR=FTR+CTC*TS, where CTR is the radius of the curved track, FTR is the radius of a first curved track of the plurality of curved tracks, CTC is a number of the curved track where the first curved track has a CTC of zero, and TS is a spacing between adjacent curved tracks,
wherein each location on the curved track has an index CI, where a first location on the curved track has a CI of zero, and
wherein the corresponding location in the next curved track for the location on the curved track has an index defined by NI=round(CI+(CI*TS)/CTR), where NI is the index of the corresponding location in the next curved track and round (·) is a rounding function.

17. The computer-readable medium of claim 15, wherein the curved tracks are one of spiral tracks and concentric circular tracks.

18. An optical disc device comprising:
an optomechanical mechanism capable of optically writing images to an optically writable label surface of an optical disc; and,
a controller to convert a rectangular image to a curved image corresponding to the optically writable label surface of the optical disc, to halftone the curved image, and to control the optomechanical mechanism to optically write the curved image as halftoned on the optically writable label surface of the optical disc.

19. The optical disc device of claim 18, wherein the controller is to halftone the curved image by:
for each curved track of a plurality of curved tracks of the optically writable label surface of the optical disc,
for each location of a plurality of locations on the curved track,
mapping the location to a corresponding location in a next curved track of the optically writable label surface, the location on the curved track mapped to the corresponding location in the next curved track that is most closely adjacent thereto; and,
employing a halftoning approach designed for rectangular images in relation to the curved image using mappings among the locations of the curved tracks.

20. The optical disc device of claim 19, wherein each curved track has a radius defined by CTR=FTR+CTC*TS, where CTR is the radius of the curved track, FTR is the radius of a first curved track of the plurality of curved tracks, CTC is a number of the curved track where the first curved track has a CTC of zero, and TS is a spacing between adjacent curved tracks,
wherein each location on the curved track has an index CI, where a first location on the curved track has a CI of zero, and
wherein the corresponding location in the next curved track for the location on the curved track has an index defined by NI=round(CI+(CI*TS)/CTR), where NI is the index of the corresponding location in the next curved track and round (·) is a rounding function.
